(19) United States
(12) Patent Application Publication
(10) Pub. No.: US 2013/0290728 A1
(43) Pub. Date: Oct. 31, 2013

(54) Method and system for a secure, searchable and sharable digital notary journal

(71) Applicant: Christopher Spence, San Antonio, TX (US)

(72) Inventor: Christopher Spence, San Antonio, TX (US)

(21) Appl. No.: 13/710,882

(22) Filed: Dec. 11, 2012

Related U.S. Application Data
(60) Provisional application No. 61/687,410, filed on Apr. 25, 2012.

(51) Int. Cl. H04L 9/32

(52) U.S. Cl. CPC H04L 9/3281
USPC 713/186

(57) ABSTRACT

Disclosed is a method and system for an electronic notary journal, to run on a smartphone or computer or similar device. Embodiments allow for the storage in local memory or in a database of data that would go in a notary journal, plus metadata. Further embodiments record digital photographs or scans of the customer, witnesses, and documents. Video of the service itself can also be included in the data. Metadata recording the time, date, and geographical location at which the notary data was saved are incorporated with the notary data.

### RELATED APPLICATION DATA

This application claims the priority of prior U.S. provisional application Ser. No. 61/687,410 filed on Apr. 25, 2012, which is hereby incorporated by reference herein in its entirety.

### TECHNICAL FIELD

Embodiments of the present invention relate to the field of document processing, particularly to the processing of documents pertaining to notaries and notarization. The disclosure relates to electronic data, meta-data associated therewith, and to electronic and network storage and retrieval of such data.

### BACKGROUND ART

Authentication is the foundation of any exchange of information or agreements. A signature on a document, for instance, is only useful insofar as the time and place of the signature, and the identity of the signatory, may be trusted. A system to authenticate document signatures, as well as oaths and other legally significant transactions, is therefore essential. For many documents and transactions, that system is notarization; the document to be authenticated is signed in the presence of a neutral officer known as a notary, who verifies the signatory's identity, and signs and seals the document in turn to attest that to the time of the signature and the signatory's identity. Notarization in turn is supported by a notary's register or journal, in which the notary records detailed information concerning the notarized transaction. Properly used, such a journal enables the notary infallibly to recall whether a particular document was in fact signed in the notary's presence. The data entered into notary journals has become standardized, with only minor variations from one jurisdiction to another in the United States; typically, where laws require notaries to keep a journal, a journal entry must identify the kind of notary service, the kind of document notarized, if any, the identity of the notary's customer, how the customer identified him- or herself, and the date, time, and address, and bear the customer's signature. Some jurisdictions require additional matters to be recorded, and the notary can always record more information as a matter of routine.

Traditionally, notaries have recorded their register entries in logbooks, which they must keep with them wherever they perform their office, and to which they must refer if it becomes necessary for them to recall a particular document or signatory. This system has served notaries well, for obvious reasons: it is simple to use, relatively portable, and, if not damaged or lost, durable. There are nonetheless many disadvantages to the traditional logbook register. First, the logbook has a limited capacity: once every entry space in the book is filled, the notary must acquire a new book, and keep the old one in some location where it can be readily retrieved. Of course, once the new book is in use, all the old book's records are not as easily available as they once were. Second, a logbook is bulky, by comparison to modern data storage methods, in which for example one hundred and fifty thousand pages of word-processed text can easily be stored in an object smaller than a penny. A logbook capable of recording a large volume of signatures is cumbersome to carry. Third, a paper logbook is not easy to search for all the elements of its data. Most record entries in chronological order, so it is a simple matter to retrieve transactions by date, but to find the name of a particular signatory requires leafing through all the pages and visually scanning them. That issue is greatly exacerbated if there are multiple volumes to search. Fourth, each logbook is in the sole possession of its notary. If the notary has died or is otherwise unavailable, another person who wishes to find the logbook entry, for example to dispel suspicions of a forged notarization, will have to locate the logbook and physically search it. Finally, the logbook can be stolen, lost, or destroyed or rendered illegible in fires or floods. The passage of time only increases the likelihood of such an event.

Although some products exist that use computer technology to assist in the notarization process, those products are directed to enhancements of the notarial act itself, rather than to improvements in the notary logbook. The computerization of the notary act itself is problematic, because of the nature of the documents to be notarized, as well as of the notary process itself For instance, a product that allows the notary to witness a transaction via videoconference is of questionable use, because notaries typically must witness the process or transaction to be notarized in person, to minimize the ability of a duplicitous customer to achieve notarization under false pretenses. Indeed, in at least some jurisdictions, notaries are prohibited to notarize anything unless in the presence of the party seeking notarization. Digitally notarized documents present similar difficulties: once the notarized document is remitted to a customer, the possibility exists that it could be altered by digital means. The act of notarization itself owes its authenticity to its immutability, and it is perhaps with good reason that the act of notarization has changed so little over the years

### SUMMARY OF THE EMBODIMENTS

It is therefore an object of the present invention to provide a process for the electronic storage and retrieval of notary registry entries. It is a further object of the present invention to present notaries with a digital notary journal that is more compact, more secure, and easier to use than a traditional logbook. It is a yet further object of this invention to make all of a notary's journal entries readily retrievable from many locations, no matter how many journal entries have been recorded. An additional object of this invention is to make notary journal entries far less susceptible to loss or theft. Still another object of this invention is to enhance the accuracy and reliability of notary journal entries by adding to the forms of data that can be entered in a journal entry, and incorporating metadata concerning each entry in the electronic record concerning the entry.

In the first embodiment of the invention, the user enters at least some notary data, data that would be required in a notary journal entry, into an electronic device such as a mobile phone, PDA, or computer, using a touchscreen, a keyboard, a mouse, or any other component or feature that allows a user to enter data in such an electronic device. That data is assembled into a custom data file. The electronic device in turn adds metadata, or data describing the circumstances of the user-input data's creation, to the custom data file, which is saved either in the electronic device's local memory or in a database.

A further embodiment of the invention stores the custom data file in such a way that a user will be able to search for custom data files by metadata. Another embodiment stores the custom data file in a manner that allows the user to search for custom data files using the user-input data. In still another embodiment, the custom data file is deleted from the electronic device's local memory once it has been entered in a database. In a further embodiment, the metadata added to the custom data file includes the data and time of the custom data file's creation, which the electronic device produces with its clock or similar facility. Another embodiment includes location data produced by the device's Global Positioning System receiver or a similar navigation component as part of the metadata. The notary data includes manually entered text in another embodiment. In another, the notary data also includes the signature of the person who sought notary service, stored as a digital image, and entered on the touchscreen of the device or a similar data-entry component. Another embodiment adds to the notary data the fingerprint or thumbprint of the person who sought notarization, entered using a reader designed to scan fingerprints. Digital photographs of notarized documents, identification documents, and people involved in the instant transaction become part of the notary data under a further embodiment. Still another embodiment incorporates scanned documents or identification documents into the data. The data can include a video of the instant transaction under a further embodiment. A final embodiment of the claimed method allows the custom data file to be write-protected, so it cannot be altered or deleted subsequent to its storage.

Another embodiment of the present invention is a system for recording an electronic journal entry. The system is an electronic device such as a mobile phone, personal digital assistant, or computer that possesses memory and a processor. The processor is programmed with software that includes a Data Capture Component, a Processing Component, and a Data Storage Component. The Data Capture Component accepts user-input notary data such as would be entered in a notary journal. The Processing Component collates that data into a custom data file, and adds metadata describing the circumstances of the notary data's creation to the custom data file. The Data Storage Component performs the functions of inserting the custom data file into the device memory or database, and searching for record entries wherever the custom data file is stored.

An additional embodiment of the system allows the Data Storage Component to delete the custom data file from the electronic device's memory when it has been added to a database. Another embodiment configures the Processing Component to include the time and date of the custom data file's creation, as produced by the electronic device's clock, in the metadata it adds to the custom data file. A further embodiment gives the Processing Component the capacity to add metadata containing the location of the device at the time of the custom data file's creation, as produced by the Global Positioning System or similar navigation means of the electronic device, to the custom data file. Yet another embodiment involves allowing the Data Storage component to write-protect the custom data file upon storage, so it cannot be modified or deleted. Still another embodiment configures the Data Capture Component to accept text manually entered via a keyboard, mouse, touchscreen, or similar facility as part of the notary data. An additional embodiment configures the Data Capture Component to accept a signature as written on a touchscreen or other data entry facility designed to record handwriting. Another embodiment configures the Data Capture Component to capture fingerprints or thumbprints entered using a reader designed for that purpose, which is either built into or paired with the electronic device in some way. The Data Capture Component, under another embodiment, can also capture digital photographs of documents and persons, as taken by a digital camera. Under another embodiment, the Data Capture Component is able to capture scanned documents, entered into the electronic device by a scanner. Finally, one more embodiment allows the Data Capture Component to include digital video footage of the instant transaction as part of the custom data file.

Other aspects, embodiments and features of the invention will become apparent from the following detailed description of the invention when considered in conjunction with the accompanying figures. The accompanying figures are for schematic purposes and are not intended to be drawn to scale. In the figures, each identical or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention.

### BRIEF DESCRIPTION OF THE DRAWINGS

The preceding summary, as well as the following detailed description of the invention, will be better understood when read in conjunction with the attached drawings. For the purpose of illustrating the invention, presently preferred embodiments are shown in the drawings. It should be understood, however, that the invention is not limited to the precise arrangements and instrumentalities shown.

FIG. 1 is a flowchart illustrating one possible embodiment of the claimed method.

FIG. 2 is a screenshot showing the initial screen of a possible embodiment of this invention, as implemented on a smartphone.

FIG. 3 is another screenshot from the same potential embodiment showing fields for the user to enter text describing the notarial transaction and the signatory.

FIG. 4 is a screenshot of the same potential implementation showing a screen wherein the user could take a photograph using a smartphone camera of the government ID presented by a signatory.

FIG. 5 is another screenshot of the same potential implementation showing a field wherein the user could enter a photograph of the document that was notarized.

FIG. 6 is another screenshot from the same potential implementation showing a field wherein the user could enter a photograph of the signatory.

FIG. 7 is another screenshot of the same potential implementation showing a field wherein the signatory could enter his or her signature.

FIG. 8 is a schematic diagram of the electronic device, including items coupled to it as defined below, and the software components incorporated into the device pursuant to this invention.

### DETAILED DESCRIPTION OF SPECIFIC EMBODIMENTS

The present invention is a method and a system that replaces the traditional notary logbook with an electronic journal in which all data formerly written in the logbook is stored electronically. The notarial transaction itself is entirely unchanged, and indeed nothing claimed herein purports to enhance or modify that process in any way. Instead, the claimed invention creates a computerized system that simulates an ordinary logbook's current functionality on a computer, or on portable mobile device such as a smartphone; the method and system as disclosed below could also be performed by more than one device, linked together by a network or other connection.

Definitions. As used in this description and the accompanying claims, the following terms shall have the meanings indicated, unless the context otherwise requires.

A “Notary” is any person authorized or licensed in any jurisdiction to perform the office of a notary.

“Notarial Transaction” is whatever service the notary performs within the scope of his or her authority as a notary, and regarding which the notary is creating a journal entry.

A “Signatory” is a person who sought the notary services associated with the record to be entered in the notary journal, including persons who are not specifically seeking to have signatures notarized.

“Notary Data” is any data that concerns a service performed by a notary in his or her capacity as a notary. Notary data includes anything that would traditionally be entered in a notary journal by custom or by law, such as the printed name of the signatory, the signature of the signatory, the time and date of the service performed by the notary, the signatory's complete address, the type of proof of identification presented by the signatory, the identification number if any on the identification means presented, the type of notarial act performed on the instant occasion, the fee charged by the notary for the service, the type of document notarized if any, the date of any notarized document, whether witnesses were present for the instant notarization, whether other signatories were present; the name, address, and signature of any witness, additional comments concerning the transaction, reason for failure or refusal of notarization if the notarization was not completed, and the fingerprint or thumbprint of the signatory.

“Metadata” is information that describes data entered in a record, including the time and date that the data was entered, the size of the data, the geographic location at which the data was recorded, the device on which it was recorded, the author of the data, and the categories of files that contain the data.

An “electronic device” is any computer, mobile phone, PDA, server, or any other device powered by electricity that may be programmed to perform arithmetic and logical operations.

A product or means is “coupled” to an electronic device if it is so related to that device that the product or means and the device may be operated together as one machine. In particular, a piece of electronic equipment is coupled to an electronic device if it is incorporated in the electronic device (e.g. a built-in camera on a smartphone), attached to the device by wires capable of propagating signals between the equipment and the device (e.g. a mouse connected to a personal computer by means of a wire plugged into one of the computer's ports), tethered to the device by wireless technology that replaces the ability of wires to propagate signals (e.g. a wireless BLUETOOTH® headset for a mobile phone), or related to the electronic device by shared membership in some network consisting of wireless and wired connections between multiple machines (e.g. a printer in an office that prints documents to computers belonging to that office, no matter where they are, so long as they and the printer can connect to the internet).

“Data entry means” as used herein is a general term for all equipment coupled to an electronic device that may be used to enter data into that device. This definition includes, without limitation, keyboards, computer mouses, touchscreens, digital cameras, digital video cameras, wireless antennas, Global Positioning System devices, microphones, gyroscopic orientation sensors, proximity sensors, compasses, scanners, specialized reading devices such as fingerprint or retinal scanners, and any hardware device capable of sensing electromagnetic radiation, electromagnetic fields, gravitational force, electromagnetic force, temperature, vibration, or pressure.

An electronic device's “clock means” is the combination of hardware and software coupled to the electronic device that enables the electronic device accurately to measure the passage of time. Practitioners of ordinary skill in this invention's technical field will be aware that conventional computers and mobile devices routinely possess built-in clocks that can calculate the current time and date, permitting the computer or mobile device to display that time and date for a user or to “timestamp” a file stored in memory. Some electronic devices connected to networks also have the ability to correct their clocks with information downloaded from the networks to improve precision and reflect any locally-mandated clock changes (such as daylight savings time); such network-based enhancements are also part of the device's clock means.

An electronic device's “navigation means” is any facility coupled to the electronic device that enables the device accurately to calculate the device's location on the surface of the Earth. Navigation means can include a receiver configured to communicate with the Global Positioning System or with similar satellite networks, as well as any other system that mobile phones or other devices use to ascertain their location, for example by communicating with cell towers.

An electronic device's “Manual data entry means” is the set of data entry components coupled to the electronic device that permit the entry of data by manual manipulation. Manual data entry means can include keyboards, mouses, touchscreens, track-pads, and signature pads.

“Biometric Data” is any physiological data that uniquely identifies a person. Biometric data includes without limitation fingerprints, thumbprints, retinal scans, facial features amenable to recognition by facial recognition systems, and Deoxyribonucleic acid (DNA) profiles.

An electronic device's “Biometric data entry means” is the set of data entry components coupled to the electronic device that record biometric data. Biometric data entry means includes without limitation fingerprint scanners, handprint scanners, retinal scanners, voice-recognition systems, and facial recognition systems. Practitioners in the art will be aware that such means exist in various stages of development at present, and in particular that fingerprint-scanning hardware that can be connected to computer ports is currently readily available on the market.

An electronic device's “optical data entry means” is a component coupled to the electronic device that records images on an electronic image sensor, for instance using a digital camera, video camera, or scanner. Persons of ordinary skill in the art will be familiar with digital cameras that may be attached to computers to transfer images, cameras that operate while attached to computers (i.e. “webcams”), and the near-ubiquitous built-in cameras that come with mobile phones. Scanners that may be used with computers or other electronic devices have existed for decades, and are known to persons of ordinary skill in this invention's technical field. Furthermore, persons of ordinary skill in the art will be aware of cameras that can be attached to computers to transfer video that they have captured, digital video cameras that operate while attached to computers (i.e. “webcams”), and the digital cameras capable of capturing video that are built into many mobile phones.

A “digital image” of a notarized document is a photo or scan of an entire document or a portion of the document showing a signatory's signature, date and a notary's stamp and signature.

A “digital image” of a notary's license means a photo or scan of the entire license, including both sides of a two-sided license.

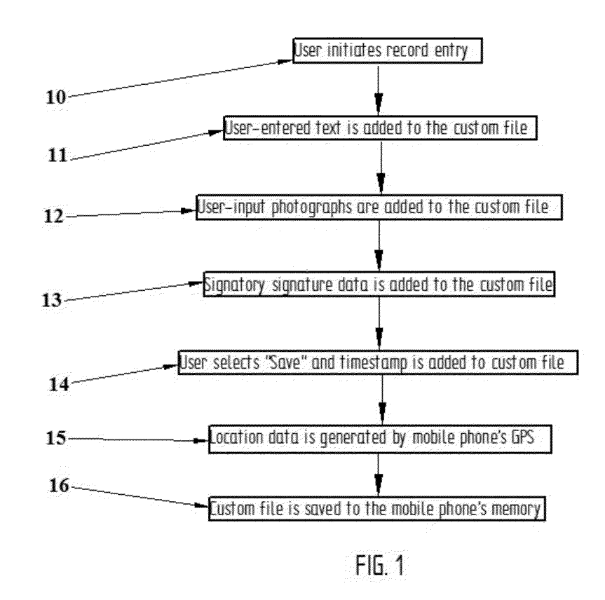

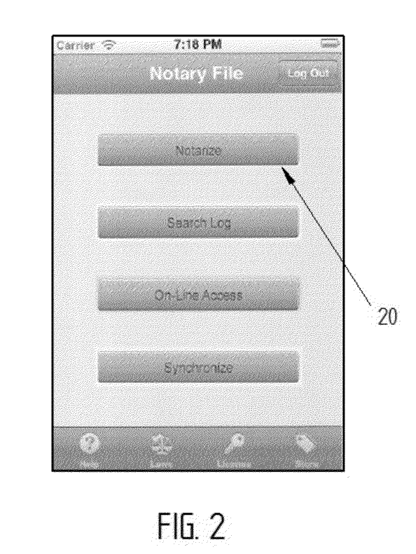

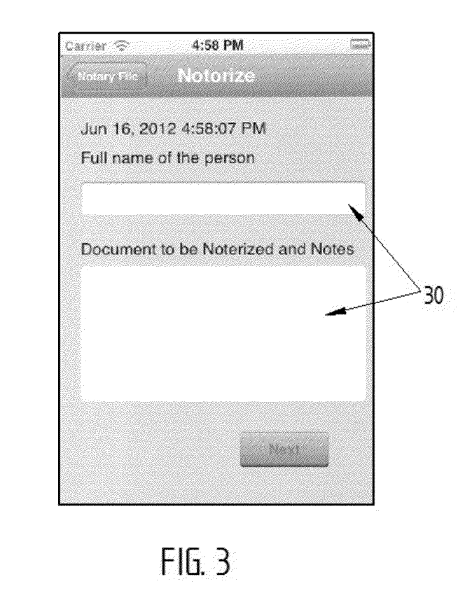

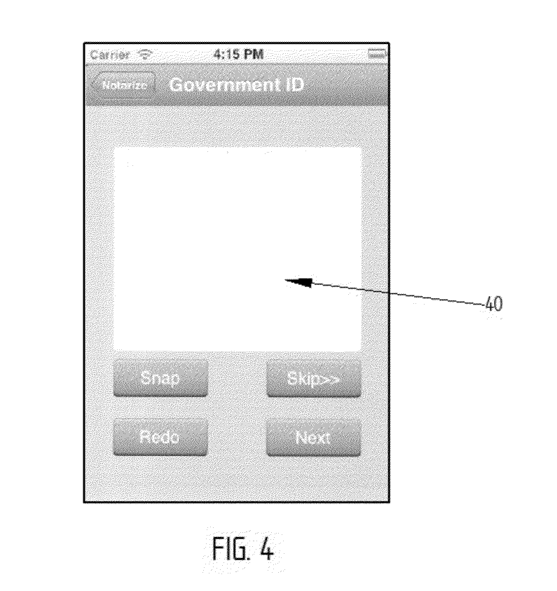

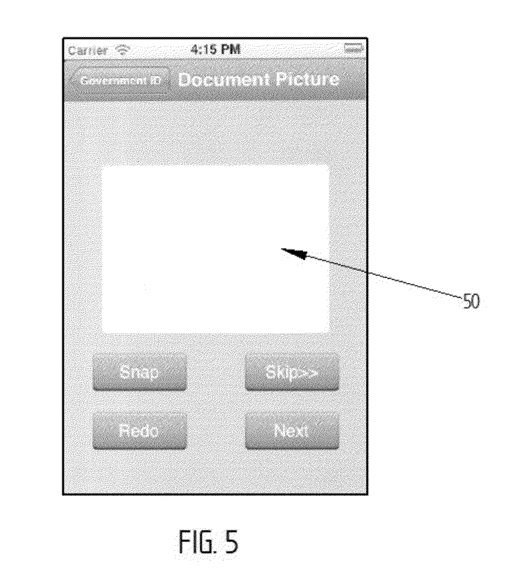

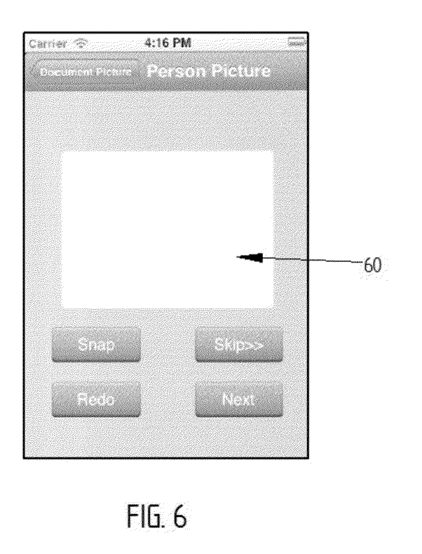

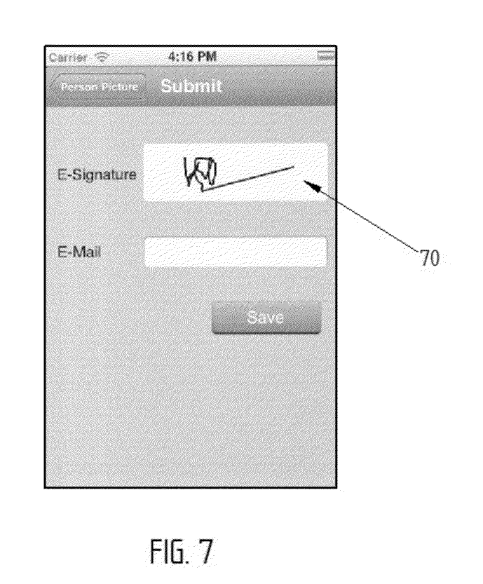

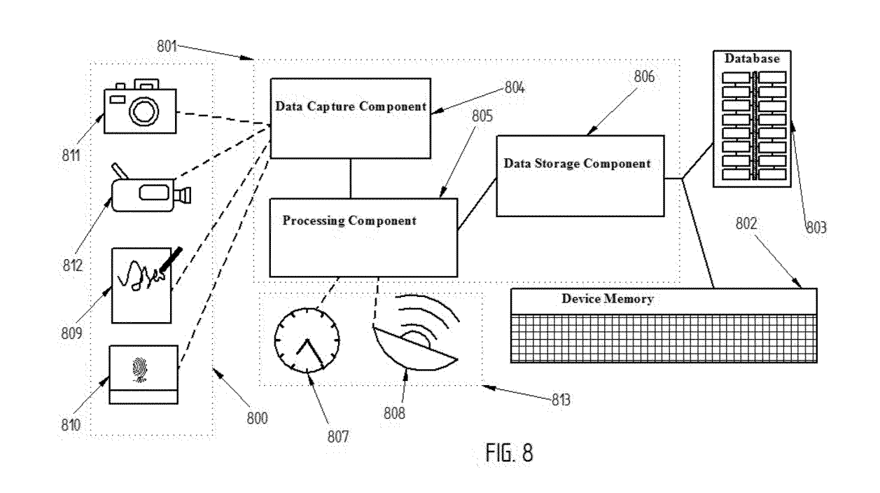

One possible embodiment of the method and system disclosed herein is illustrated by the flow chart in FIG. 1, and screenshots of that possible embodiment's graphical user interface as implemented on a smartphone (FIG. 2-FIG. 7). For further elucidation of this embodiment, see the schematic system diagram in FIG. 8. The user selects “Notarize” 20 on the initial screen FIG. 2, initiating 10 the record entry process FIG. 1. The system accepts text data 11 via user inputs 30 on the phone's touch screen FIG. 3 naming the signatory or signatories and describing the notarial transaction. In the subsequent screen FIG. 4 the user takes photographs 40 of the identification document that the signatory presented to the notary. As more notary data, in a further screen FIG. 5, the user takes photograph of the notarized document 50, and in the next screen FIG. 6 of the signatory 60. All of those photographs are entered 12 as the next step in the method FIG. 1. The signature 70 of the signatory is captured FIG. 7, added in the subsequent step 13 in the method FIG. 1, and then the user selects “Save” 14. The date and time that the record is entered is recorded 15 as metadata produced by the phone, along with metadata 16 that records the mobile device's current location at that time, as produced by the mobile phone's Global Positioning System receiver.

The use of a computerized process to record journal entries has several distinct advantages over the use of a traditional logbook. The use of a digital process allows for more compact and readily legible storage of journal entries, and permits them to be backed up, thus largely eliminating the risk that the entries can become lost and other similar concerns. Location data calculated by the phone itself represents a more accurate and more generally useful way to record the location of the notarial transaction. The use of digital photographs presents a new and superior way to record the identity of the signatory, defined herein as the person seeking the notary's services, and of any witnesses. Finally, the digital record book is immensely easier to search for past entries than its paper counterpart.

The overall approach used in the method embodiments of this invention is as follows: the user enters notary data describing the just-completed notarial transaction in an electronic device FIG. 8 via its data entry means 800. This data is assembled together, and metadata generated by means 813 coupled to the electronic device is added to it. Finally, the notary data and metadata together are stored in the device's memory 802 or in a database 803. The system embodiments implement a similar functionality as illustrated by FIG. 8. All of the notary data is entered via the electronic device's data entry means 800, and the electronic device's processor 801 is configured via software instructions to capture that data with a Data Capture Component 804. Further software instructions enable the processor to compile the notary data custom data file by means of a Processing Component 805, which also accepts metadata generated by facilities 813 coupled to the device, and adds the metadata to the custom data file. Finally, another set of software instructions configures the device processor to operate a Data Storage Component 806, which stores records to the device memory 802, or to a database 803, which may be in the device's memory itself, or may be operated elsewhere, but coupled to the device. The Data Storage Component also has the capacity to search the memory or database by metadata, or by notary data.

The option to store the custom data file in a database represents another advantage to computerized storage of records that cannot be replicated by other means. A database is a structured collection of data, which can divide the data stored into fields representing useful categories of data. As a result, a stored data record can be quickly retrieved using any known portion of the data that has been stored in that record by searching within that known datum's category within the database. A database can be created in any digital memory. Thus, the final method step in the embodiment of this invention introduced above could involve storing the custom data file in a database 803 created on the electronic device FIG. 8 that recorded the data, or it could involve storing the custom data file in a locally or remotely located database. The ability to use networks to send data to a remote database is a matter of long-established knowledge in the art, as is the ability to search the databases; indeed, the latter is an inherent property of databases, and the principal reason for their existence. Indeed, since all data stored in electronic device memory must be retrievable to be useful, and once retrieved can always be parsed for its component elements, some ability to search by categories of data is an inherent characteristic of virtually all electronically stored data. One embodiment of the invention calculated to exploit that ability to search local and remote databases, as well as the ability of a device to search its local memory (also inherent in any electronic device as defined herein) makes the custom data files searchable by metadata or notary data. As is readily apparent from the foregoing discussion, to make the data searchable by any category of data requires little more than organizing the data according to such categories. The system embodiment described above establishes the same searchability by metadata and notary data in its definition of the Data Storage Component.

The ability to store and locate a data file implies another ability that persons of ordinary skill in the art will recognize as inherent in electronic devices, which is the ability to delete files from memory. Thus, another embodiment of the method disclosed herein adds the ability to delete the custom file from the device memory 802 if it has been recorded in the database 803, to avoid occupying too much of the device memory's capacity. Likewise, the system here disclosed can implement that method step by configuring the Data Storage Component 806 to delete the custom data file from the device memory 802 if it has been stored in a database 803.

The use of metadata is another unique advantage of digital record storage. As noted above, electronic devices frequently possess clock means 807, which allow them to record the current time and date to a degree of accuracy and infallibility beyond the reach of human effort. Likewise, the ability to add that time to the custom data file automatically upon storage without human intervention adds indicia of reliability to the custom data file as a whole, particularly if the metadata is proof against modification. An additional embodiment of this invention implements a method step in which the time and date generated by the clock means is added to the custom data file. Another embodiment adds to the system as disclosed heretofore by specifying that the Processing Component 805 is configured to receive metadata from the device's clock means 807 and add that metadata to the custom file. Similarly, another method embodiment exploits electronic devices' ability to ascertain their location accurately using their navigation means 808 to add the method step of including location metadata in the custom data file. The corresponding system embodiment adds the same capability to the system claims by configuring the Processing Component 805 to accept metadata from the device's navigation means 808. Both kinds of metadata can be used to verify the accuracy of the notary's own recorded information, as well as providing another category of data usable to locate the custom data file wherever it has been stored.

The notary data is the data that most directly replicates the traditional logbook entries, as the definition above makes clear. One embodiment of the invention simply stores the notary data as text, entered using the device's manual data entry means 809. The same embodiment in terms of the system involves configuring the Data Capture Component 804 to receive notary data in the form of text that is entered via the manual data entry means 809 of the device. Other kinds of notary data require more sophisticated technology. The requirement that a notary journal entry be signed by the signatory is replicated in the embodiments of the present invention by use of a digitally captured signature. As noted above, existent and familiar technologies allow a person to enter a signature in an electronic device just as if signing with a pen on paper, by means of manual data entry means 809 coupled to the electronic device. This can be incorporated into the present invention in the form of a method step in which the digital image thus produced is contemplated in these embodiments as a user input that will be a part of the record to be saved as a digital journal entry in the memory of the electronic device; Similarly, a system embodiment gives the Data Capture Component 804 the ability to accept signature data from the device's manual data entry means 809.

Some jurisdictions require notary logbooks to record the thumbprint of the signatory, or an equivalent biometric proof of identity. As noted above, devices that can read biometric data such as fingerprints and retinal scans are known to persons of ordinary skill in the art, and may be attached to or incorporated in computers or mobile devices. Searchable databases of fingerprint records in particular already exist, as should be apparent to persons of ordinary skill in the art; they are typically used today by law enforcement. One embodiment of this invention incorporates biometric data as produced by biometric data entry means 810 coupled to the electronic device into the data to be stored as an electronic journal record. A corresponding system embodiment adds to the Data Capture Component 804 the ability to receive a fingerprint image from biometric means 810 coupled to the electronic device.

The use of digital photographic technology in recording journal entries is a technique that would not be available in a traditional logbook, but which furthers the logbook's traditional goals of accuracy and authenticity. An additional embodiment of this invention involves using the digital image produced by digital camera means 811, well-known to persons skilled in the art, to create a digital photograph of the signatory, of any witness to the notarial transaction, and any identification document that either category of person produces to verify their identity, and adding that to the custom data file. Additional photographs can also be taken of the notarized document or a portion thereof, and of the notary license. A corresponding system embodiment configures the Data Capture Component 804 to receive digital images from the electronic device's digital camera means 811. This addition to the traditional notary journal fields provides an further way for the notary to verify the authenticity of the notarial transaction after the fact: the photograph of the signatory or witness can be compared to the image of that person's photographic identification document, for example. Likewise, photographs of a notarized document, a signatory, or a witness serve to correct any errors of entry that the notary might inadvertently make with regard to the objects or persons photographed. Scanning the documents produces a similar benefit to photographing them, and uses another well-established technology, as noted above. An additional embodiment of the invention involves using a feature known to be common in digital cameras to videotape the notary process, and add that data to the custom data file. The corresponding system embodiment configures the Data Capture Component 804 to accept video data from optical data entry means 812 capable of recording video data. The use of this video data enables the notary to check after the fact for irregularities and to support his or her memory of the events at the notarial transaction.

And yet another embodiment is directed to turn one of digital storage's few drawbacks into an advantage. Paper records are far more difficult to tamper with than digital records, due to the very flexibility that makes digital storage so convenient. However, as practitioners of ordinary skill in the art will be aware, the custom data file can be stored, once assembled, in “read-only” form. When so stored, the file cannot be modified or deleted by any user. This offers some degree of protection against mischievous or unintentional modification of the record data to be relied upon for the purposes of authenticating notarial transactions. Although it is true that a determined malefactor could conceivably find ways around security to remove the write-protection from the file, the effort involved in so doing could be substantial, depending on the quality of the underlying system. At the very least, write-protection can place the modification of the custom data file beyond the reach of persons who do not possess specialized skills or equipment. This can be accomplished in the present invention by write-protecting the custom data file in the database or device memory, once stored. Likewise, the Data Storage Component 806 may be configured to write-protect the custom data file either in the device memory 802 or in the database 803.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. A method for recording a notary journal entry for a notary electronically, performed by an at least one electronic device, comprising:
generating notary data using the electronic device's data entry means;
compiling said notary data and embedding metadata associated with the notary data into a custom data file; and storing the custom data file in a form that is searchable by metadata or notary data in at least one of
the memory of the electronic device and a database.

2. A method according to claim 1, further comprising deleting the custom data file from the memory of the electronic device after custom data file has been stored in the database.

3. A method according to claim 1, wherein the metadata includes the date and time that the custom data file was created, as generated by the electronic device's clock means.

4. A method according to claim 1, wherein the metadata includes a location of the electronic device at the time the custom data file was created, as calculated by the electronic device's navigation means.

5. A method according to claim 1, wherein the notary data includes text manually entered via manual data entry means of the electronic device.

6. A method according to claim 1, wherein the notary data includes a signature of a signatory, entered via manual data entry means of the electronic device.

7. A method according to claim 1, wherein the notary data includes biometric data as recorded by biometric data entry means coupled to the electronic device.

8. A method according to claim 1, wherein the notary data includes a digital image of at least one of a notarized document, signatory, witness, signatory's identification document (ID) and notary's license as recorded by optical data entry means coupled to the electronic device.

9. A method according to claim 1, wherein the notary data includes a digital video of the notarial transaction as recorded by optical data entry means coupled to the electronic device.

10. A method according to claim 1, wherein the custom data file is protected so that it is not editable.

11. A system for recording a notary journal entry for a notary electronically, the system comprising:
at least one electronic device coupled to data capturing means; the electronic device having a memory and a processor coupled to the memory, the processor operable to execute instructions to perform functions comprising:
a data capture component configured to capture notary data generated by said data entry means;
a processing component configured to compile the notary data and embed metadata associated with the notary data into a custom data file; and
a data storage component configured to store the custom data file, and to search for files by notary data or metadata in the memory of the electronic device or in a database coupled to the electronic device.

12. A system according to claim 11, wherein the data storage component is further configured to delete the custom data file stored in the memory of the electronic device upon receiving confirmation that the custom data file is stored in the database.

13. A system according to claim 11, wherein the processing component is configured to embed as metadata the date and time that the custom data file was created, as generated by the electronic device's clock means.

14. A system according to claim 11, wherein the processing component is configured to embed as metadata the location of the electronic device determined by the navigation means of the electronic device at the time the custom data file was created.

15. A system according to claim 11, wherein the data storage component is configured to protect the custom data file so that it is not editable.

16. A system according to claim 11, wherein the data capture component is configured to capture text manually entered via manual data entry means coupled to the electronic device.

17. A system according to claim 11, wherein the data capture component is configured to capture a signature, entered via manual data entry means coupled to the electronic device.

18. A system according to claim 11, wherein the data capture component is configured to capture biometric data as recorded by biometric data entry means coupled to electronic device.

19. A system according to claim 14, wherein the data capture component is configured to capture a digital image of at least one of a notarized document, signatory, witness, signatory's identification document (ID) and notary's license as recorded by optical data entry means coupled to the electronic device.

20. A system according to claim 14, wherein the data capture component is configured to capture a digital video of the notarial transaction as recorded by digital video camera means coupled to the electronic device.
